(19) United States
(12) Patent Application Publication
(10) Pub. No.: US 2015/0149333 A1
(43) Pub. Date: May 28, 2015

(54) CASH FLOW MANAGEMENT

(71) Applicants: Allene Yaplee, San Jose, CA (US); Steven Chien, Menlo Park, CA (US)

(72) Inventors: Allene Yaplee, San Jose, CA (US); Steven Chien, Menlo Park, CA (US)

(21) Appl. No.: 14/091,161

(22) Filed: Nov. 26, 2013

(51) Int. Cl. G06Q 40/00

(52) U.S. Cl. CPC G06Q 40/12
USPC 705/30

(57) ABSTRACT

Methods and systems for managing merchant cash flow are described. A service provider accesses a large volume of merchant financial data collected and/or received to provide a meaningful forecast on merchant cash flow. Based on the forecast (e.g., positive or negative cash flow position), the service provider can provide options (e.g., credit, loan, deferred payment, etc.) to the merchant.

### BACKGROUND

1. Field of the Invention

The present invention generally relates to cash flow management systems and methods, and more specifically, to managing a merchant's flow of income to assure a non-negative cash flow.

2. Related Art

Financial planning, savings, and investment strategizing for an individual, family, or business entity often pays inadequate attention to cash flow management, which can result in negative cash flow or other adverse financial parameters. This may be particularly true for merchants who are, perhaps, just starting their own business, or are small businesses. Accordingly, a method and system is needed for assuring a non-negative cash flow in the context of healthy financial parameters.

### BRIEF DESCRIPTION OF THE FIGURES

FIG. 1 is a block diagram of an exemplary system for managing a merchant cash flow according to an embodiment of the present disclosure;

FIG. 2 is a flowchart showing the steps for managing a merchant cash flow according to an embodiment of the present disclosure;

FIG. 3 is an illustration of a screen that may be displayed to a merchant with sales forecast data according to an embodiment of the present disclosure;

FIG. 4 is an illustration of a screen that may be displayed to a merchant with cash forecast data according to an embodiment of the present disclosure; and

FIG. 5 is a block diagram of a system for implementing one or more components in FIG. 1 according to an embodiment of the present disclosure.

Embodiments of the present disclosure and their advantages are best understood by referring to the detailed description that follows. In addition, the present disclosure may repeat reference numerals and/or letters in the various examples. This repetition is for the purpose of simplicity and clarity and does not in itself dictate a relationship between the various embodiments and/or configurations discussed.

### DETAILED DESCRIPTION

In general, accounting is a system of recording, reporting, analyzing, verifying, and summarizing business and financial transactions for a business. The purpose of accounting is to give business owners and the public a reliable and standard measure of the financial performance of a company.

Cash flow statements provide additional information to business owners. In business, items that are purchased are often purchased on credit or paid for at a time in the future. These purchases are referred to as accounts payable.

Items that are sold may not result in cash immediately being paid to the business. Items that are sold are often sold on credit and the actual money may be received in the future. On an accrual basis, the sale may be reflected immediately as an asset (an account receivable) on the corporation's accounting system.

Also affecting actual cash flow is the beginning amount of cash that the corporation may have. Usually, corporations have multiple bank accounts and the total of these accounts makes up a beginning cash balance position. Cash flow may be difficult to manage because the flow of cash into and out of a business is not consistent. A business may write hundreds of checks in a month, significantly compounding cash flow problems. Similar problems exist in receiving payment for services.

To better assist a business in determining a cash flow position at a point of time in the future, businesses attempt to project sales. These projections can be based on sales quotes that a business has created and sent to prospective customers. In the alternative, the projections may be based on other relevant information such as historical patterns or based on data entered by the business.

In addition, expenses can be projected. These projections can be based on responses to requests for proposals that the business has sent out to its suppliers previously. In the alternative, the projections can be based on historical patterns or by data entered by the business.

By adding the beginning cash balance, the sales forecast, the receivables and subtracting the payables and the expense forecast, a projection of the cash flow for a date or a plurality of dates in the future can be created.

The present disclosure provides methods and systems that can be used by a merchant to predict and manage cash flow. The present methods and systems provide enhanced flexibility and control as to when and how payments are made that go beyond traditional bank and credit card payments. A service provider is able to access the large volume of merchant financial data collected and/or received and use this information to provide a meaningful forecast on future cash flow. Based on the forecast (e.g., positive or negative cash flow position), the service provider can provide options (e.g., credit, loan, deferred payment, etc.) to the merchant.

A merchant may refer to any individual or entity offering a product for sale. A product offered for sale by a merchant may include a variety of items. For example, a product for sale may include a good, such as merchandise, food, or any tangible object. Alternatively or in addition, the product may include a service, such as installation or repair work. Furthermore, the product may include entertainment, such as a musical concert or a theatrical performance. Generally, a merchant's stream of income is generated from the sale of such products. Other sources of income such as investment interests or donations, however, may be included in a merchant's cash flow stream.

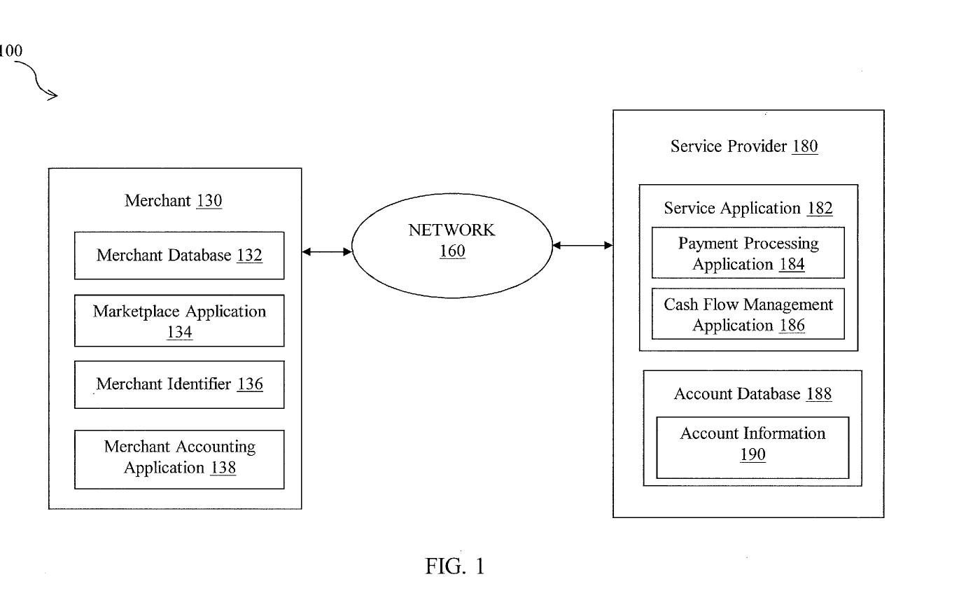

FIG. 1 shows one embodiment of a block diagram of a network-based system 100 adapted to manage a merchant cash flow. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a merchant device 130 (e.g., network computing device) and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The merchant device 130, in various embodiments, may be maintained by one or more business entities (or in some cases, by a partner of a business entity that processes transactions on behalf of business entities). Examples of businesses entities include merchant sites, brick-and-mortar stores, resource information sites, utility sites, real estate management sites, social networking sites, etc., which offer various items for purchase and payment. The merchant device 130 may include a merchant database 132 for identifying available items for sale, which may be made available to a user device for viewing and purchase by a consumer. In one or more embodiments, the consumer may complete a transaction such as purchasing the items via service provider server 180.

The merchant device 130, in one embodiment, may include a marketplace application 134, which may be configured to provide information over the network 160 to a user device. For example, a consumer may interact with the marketplace application 134 through the user device over the network 160 to search and view various items available for purchase in the merchant database 132.

The merchant device 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, a consumer may conduct transactions (e.g., searching, selection, monitoring, purchasing, and/or providing payment for items) with the merchant device 130 via the service provider server 180 over the network 160.

In various embodiments, the merchant device 130 also includes a merchant accounting application 138. The accounting application 138 records, processes, and displays accounting transactions such as accounts payable, accounts receivable, credit, payroll, balances, sales forecasts, and cash flow forecasts.

The service provider server 180, in one embodiment, may be maintained by a transaction processing entity, which may provide processing for financial transactions and/or information transactions between the consumer and merchant device 130. As such, the service provider server 180 includes a service application 182, which may be adapted to interact with a user device over the network 160 to facilitate payment. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the consumer and a merchant. In one implementation, the payment processing module 184 assists with resolving financial transactions through validation, delivery, and settlement. As such, the service application 182 in conjunction with the payment processing module 184 settles indebtedness between the consumer and a merchant, wherein accounts may be directly and/or automatically debited and/or credited of monetary funds in a manner as accepted by the banking industry.

The service application 182, in various embodiments, includes a cash flow management application 186 for managing merchant cash flow. The cash flow management application 186 collects financial information regarding merchants, analyzes this information, and makes a prediction regarding the merchant cash flow position for a date or a plurality of dates. For example, the application 186 can look at past trends or behavior to determine future sales information. Based on the prediction, the cash flow management application 186 can recommend options to the merchant to prevent a cash shortfall, and even facilitate the processing of a selected option.

The service provider server 180, in one embodiment, may be configured to maintain one or more consumer accounts and merchant accounts in an account database 188, each of which may include account information 194 associated with one or more individual consumers and/or merchants. For example, account information 194 may include private financial information of a consumer and/or merchant, such as one or more account numbers, passwords, credit card information, banking information, or other types of financial information, which may be used to facilitate financial transactions between the consumer and a merchant.

In one implementation, the merchant may have identity attributes stored with the service provider server 180, and the merchant may have credentials to authenticate or verify identity with the service provider server 180. Merchant attributes may include personal information, banking information and/or funding sources as previously described. In various aspects, the merchant attributes may be passed to the service provider server 180 as part of a login and/or search, and the merchant attributes may be utilized by the service provider server 180 to associate a merchant with one or more particular merchant accounts maintained by the service provider server 180.

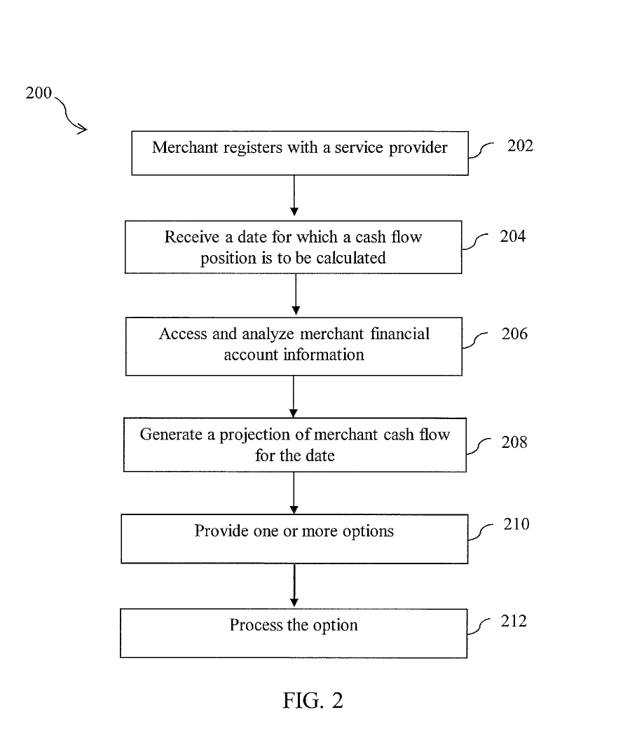

Referring now to FIG. 2, a flowchart of a method 200 for managing a merchant cash flow is illustrated according to an embodiment of the present disclosure. In an embodiment, at step 202, the merchant registers with a service provider, such as eBay or PayPal. Registration may include signing up for the cash management service and agreeing to any terms required by the service provider, such as through merchant device 130. Registration may be done completely through the merchant device 130, partially through the merchant device 130, or without using the merchant device 130, such as through a phone call or in-person visit to a representative of the service provider.

The merchant may be requested to provide specific information for registration, such as, but not limited to, a merchant name, type of goods/services offered, consumer type (e.g., individuals or businesses), address, location(s) of planned sales, phone number, email address, website address (if applicable), social security or tax ID number, a user name for the account, and a password or PIN for the account. The type of information may depend on whether the merchant already has an account with the service provider. Even if the merchant has an account, the merchant may be requested to register for this particular service, such as by providing specific information and agreeing to certain terms and conditions. Requested information may be entered through the merchant device 130 or other means, including voice or manual key entry. Once all the requested information is received and confirmed, the service provider may create an account for the merchant and/or offer the service to the merchant.

At step 204, a merchant enters and the service provider receives a date for which a cash flow position is to be calculated. The date may be the date the merchant desires to know the projected cash flow position. In addition, the date may be a date range, such as the cash flow over the next week, the next month, the next year, or the projected cash flow between a start date and an end date.

A beginning cash balance, beginning accounts receivable total, and beginning accounts payable balance may be displayed for the selected date or the range of dates. The beginning cash balance may be from a single account or a total of the balance of the businesses' various accounts as of the date or during a range of dates. The accounts receivable total may be a total of all the individual account receivables already entered into the system and are expected to be received as of the date. The beginning accounts payable total may be a total of individual accounts payable already entered into the system and expected to be paid by the date.

The balances may be automatically retrieved from different accounting modules or directly from banking institutions. The individual receivables that are used to create the receivable total may be automatically retrieved from different accounting modules. The individual payables that are used to create the payable total may be automatically retrieved from different accounting modules.

At step 206, the service provider server 180 accesses and analyzes merchant financial account information. This information can be inputted by the merchant (e.g., via the merchant accounting application 138) or retrieved from a database (e.g., account database 188). The merchant financial account information may include accounts payable, accounts receivable, balances, credit, sales information (display, pricing, distribution, etc.), product information, store information, geographic information, sales trends or patterns, timing of payments, etc. Moreover, the merchant financial account information is not limited to a single merchant, and in some embodiments, encompasses a plurality of merchants. For example, the merchant financial account information can be grouped according to industry (e.g., restaurant, travel, entertainment, clothing, etc.), location (e.g., city, state, country, etc.), and target population (e.g., teens, young adults, young families, etc.). The service provider server 180 has access to a large volume of data from a plurality of merchants in different industries, locations, and target populations. Advantageously, the service provider already has the market research to understand the merchant's target audience and their needs.

In some embodiments, the service provider server 180 analyzes past transactions for a single merchant, or across a specific industry for patterns, and sales amounts, categories, and relative frequencies are considered. The service provider server 180 can determine whether one or more trends are occurring or have occurred, and use this information to predict how well or how poorly sales for a merchant will be. Retail sales trends may be, for example, a reaction to a particular marketing event or a weather related event in the area.

At step 208, the service provider server 180 creates or generates a merchant cash flow forecast for the merchant based on the merchant financial account information. The forecast may be adjusted based on received information. For example, the service provider server 180 adds the beginning cash balance, the sales forecast, the accounts receivables and subtracts the accounts payables and the expense forecast to determine the merchant cash flow.

In various embodiments, a graph (e.g., a bar graph or a line graph) of projected cash flow over a period of time may be displayed. A bar graph will display bars at even time intervals over the selected period of time, whereas a line graph will show the projected trend over the selected period of time with data points selected evenly over the period of time.

At step 210, based on the projection (e.g., negative cash flow), the service provider server 180 provides one or more options to the merchant to assure that a positive cash flow position is achieved on the date. The options, in one embodiment, may be selected from a drop-down menu displaying the different options. The options may include providing credit to the merchant (e.g., PayPal's Bill Me Later®), providing a business loan to the merchant (e.g., PayPal Working Capital), building a better budget, cross-border selling (e.g., offering products to consumers in another country), delaying payment of bills (e.g., negotiate longer payment terms), and/or promoting/advertising merchant items. Other suitable options include recommendations to pursue unpaid invoices, launching a sale, issuing coupons, offering credit sparingly (e.g., collecting up-front instead of extending credit to a consumer), providing incentives through discounts for early payments, and offering easy payment plans and simple online options such as PayPal.

At step 212, the merchant selects at least one of the options and the service provider server 180 processes the option. For example, the service provider issues credit to the merchant or grants a business loan to the merchant.

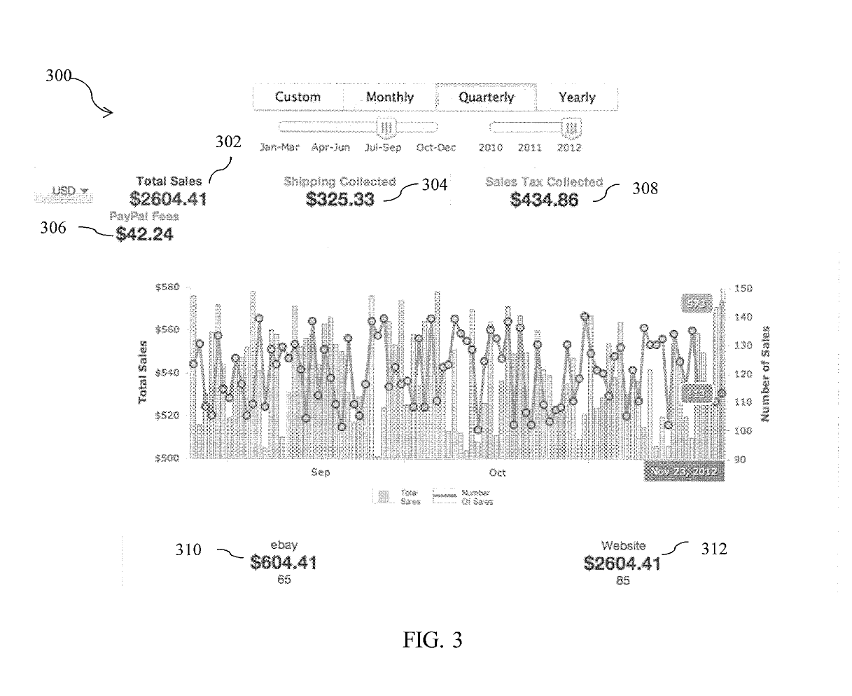

FIG. 3 illustrates an example display screen 300 of a sales forecast according to an embodiment. In one embodiment, the service provider uses data that dates back 13 months to eliminate noise caused by seasonality. In cases where a merchant does not have 13 months' worth of data, the service provider can use a smaller sample size. In various embodiments, the service provider models sales trends in the past and applies those trends to current data, such as outstanding invoices and planned promotions, to derive a sales forecast.

As shown in FIG. 3, the sales forecast provides both the total sales amount and the number of sales. In this example, the date selected by the merchant is Nov. 23, 2012. The total sales 302, shipping fees collected 304, service provider fees 306, sales tax collected 308, eBay sales 310, and website sales 312 are all displayed to the merchant. The total sales 302 is equal to the sum of net sales (not shown), shipping collected 304, sales tax collected 308, and service provider fees 306. In an embodiment, a merchant may collect shipping and tax on every transaction, but not settle with the shipping provider and tax authority until the end of the quarter or month. In this case, the tax and shipping collected become usable cash until payment is due to the shipping provider and tax authority. The collected tax and shipping, however, are not counted as part of the merchant's net income. In other embodiments, the service provider gives merchants the option to set aside cash to pay for their estimated tax liability. In yet another embodiment, the service provider provides the merchant with their potential tax liability, revenue, or both in different scenarios that are based upon, for example, different tax treatments or revenue recognition. These features are valuable to merchants who want to manage their cash flow, especially smaller merchants who may not have significant financial resources.

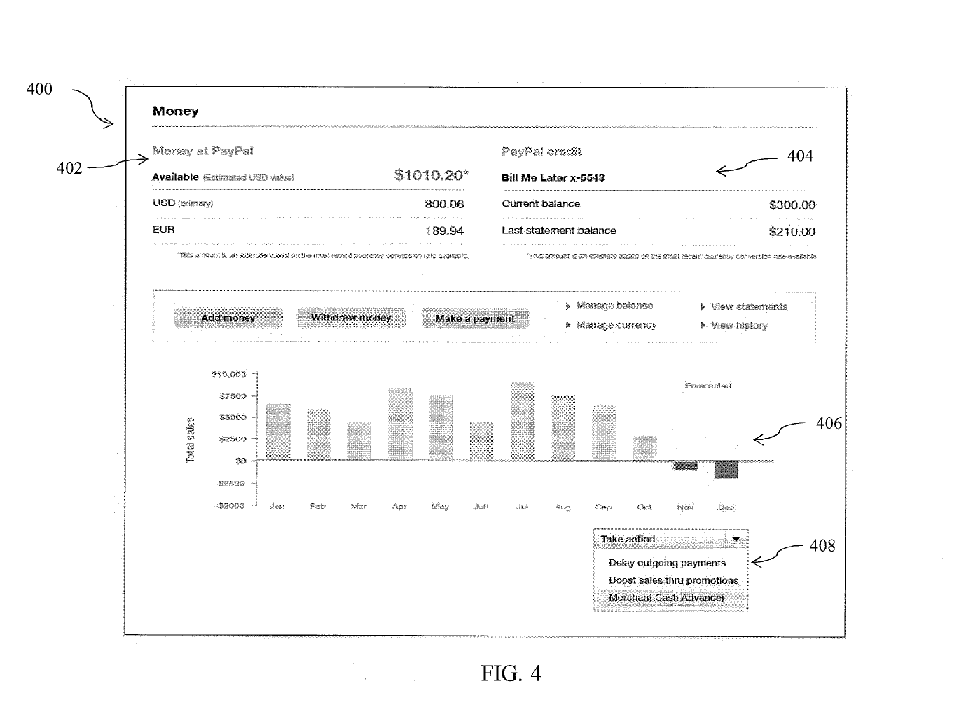

FIG. 4 illustrates an example display screen of a cash flow forecast with recommendations. Cash flow may be determined using a variety of information. For example, a merchant may provide data to the service provider, a parent company may enter information for a subsidiary for an overall cash flow position, as well as to view the cash flow position of each sub-account, the service provider may review holds and reserves getting released and review scheduled future add-fund requests, or combinations thereof. In an embodiment, the cash flow forecast uses the sales forecast information discussed above as inflow, and invoices received, bill payments due, potential reserves or holds placed on the account by the service provider, future scheduled withdrawals, and refunds in progress as outflow.

As shown in FIG. 4, an available cash balance 402 and credit 404 is displayed in a section of the display. The cash balance 402 shows how much money the merchant has with the service provider, and the credit 404 shows how much is owed to the service provider. A sales forecast 406 for November and December is displayed in graph form underneath the cash balance 402. As can be seen, the projected sales in November and December are negative. Accordingly, recommendations 408 are provided to the merchant in a drop-down menu. As illustrated, the merchant can choose from delaying outgoing payments, boosting sales through promotions, and receiving a merchant cash advance.

In various embodiments, the merchant may be selling a product (“Product X”) that includes different parts. Thus, the service provider may be provided with information regarding different parts needed to build Product X. The service provider is able to use this information to inform a merchant of an upcoming outbound cash item or upcoming liability in cash flow. This information may be displayed in either a sales forecast screen (e.g., FIG. 3) or a cash flow forecast screen (e.g., FIG. 4). The merchant may decide to initiate a purchase with a supplier of the parts (who may also have an account with the service provider). The merchant may choose to buy or order the supplies now or accept that the outbound cash flow be included in the cash flow forecast.

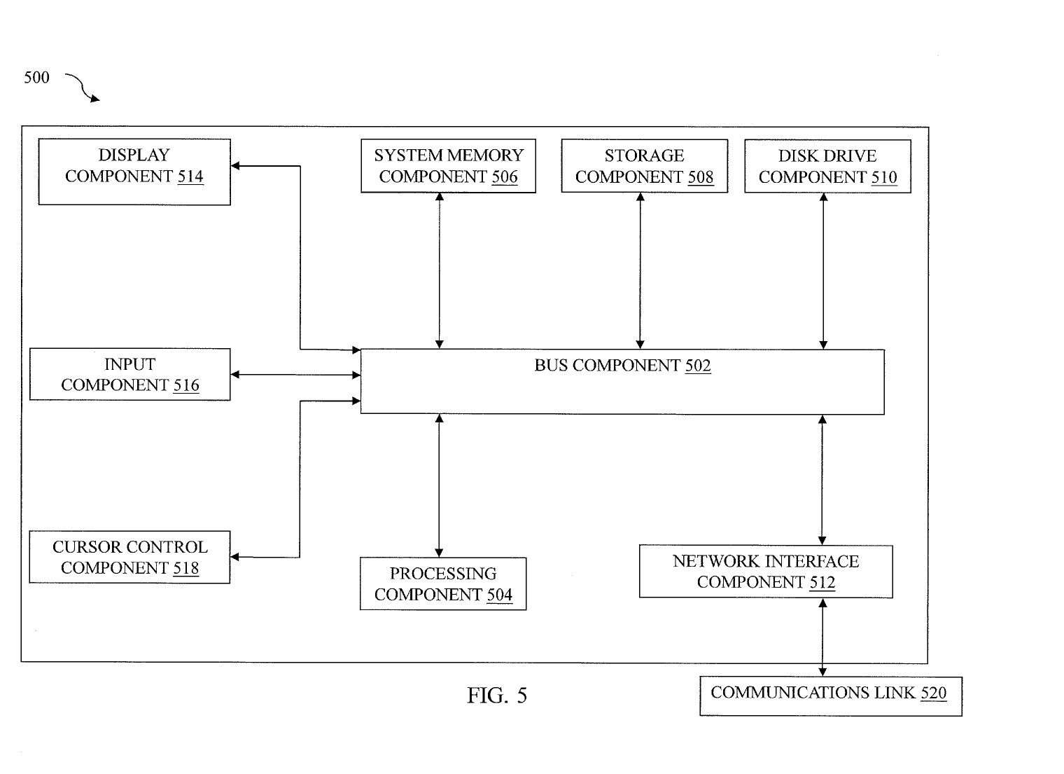

Referring now to FIG. 5, a block diagram of a system 500 is illustrated suitable for implementing embodiments of the present disclosure, including merchant device 130 and service provider server or device 180. System 500, such as part of a cell phone, a tablet, a personal computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to process financial transactions, generate a sales forecast or cash flow forecast, recommend options for assuring a positive cash flow, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., network 160 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for managing merchant cash flow.

Although various components and steps have been described herein as being associated with merchant device 130 and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

1. A system, comprising:
a memory device storing merchant financial account information; and
one or more processors in communication with the memory device and operable to:
receive a date for which a cash flow position is to be calculated;
analyze merchant financial account information;
generate a merchant cash flow forecast based on the merchant financial account information as of the date; and
provide one or more options to assure that a positive cash flow position is achieved on the date, wherein the one or more options comprises a business loan option and a promotion option.

2. The system of claim 1, wherein the merchant financial account information comprises historical patterns or trends, receivables, payables, balances, and credits.

3. The system of claim 1, wherein the one or more processors is further operable to display the merchant financial information.

4. The system of claim 1, wherein the one or more processors is further operable to generate a merchant sales forecast amount as of the date based on the merchant financial account information.

5. The system of claim 1, wherein the merchant financial account information comprises financial account information of a plurality of merchants.

6. The system of claim 1, wherein the one or more options comprises providing a credit, building a budget, suggesting cross-border opportunities, suggesting coupons, delaying outgoing payments, or combinations thereof.

7. The system of claim 1, wherein the one or more processors is further operable to receive a selection of the one or more options.

8. The system of claim 7, wherein the one or more processors is further operable to process the selection of the one or more options.

9. A method for managing a merchant cash flow, comprising:
receiving, by one or more hardware processors of a service provider, a date for which a cash flow position is to be calculated;
analyzing merchant financial account information;
generating a merchant cash flow forecast based on the merchant financial account information as of the date; and
providing one or more options to assure that a positive cash flow position is achieved on the date, wherein the one or more loan options comprises a loan option.

10. The method of claim 9, further comprising displaying the merchant financial account information.

11. The method of claim 9, wherein the merchant financial account information comprises financial account information of a plurality of merchants.

12. The method of claim 9, wherein the one or more options comprises providing credit, building a budget, suggesting cross-border opportunities, suggesting promotions or coupons, delaying outgoing payments, or combinations thereof.

13. The method of claim 9, further comprising receiving a selection of the one or more options.

14. The method of claim 13, further comprising processing the selection of the one or more options.

15. A non-transitory machine-readable medium comprising a plurality of machine-readable instructions which, when executed by one or more processors, are adapted to cause the one or more processors to perform a method comprising:
receiving, by a service provider, a date for which a cash flow position is to be calculated;
analyzing merchant financial account information;
generating a merchant cash flow forecast based on the merchant financial account information as of the date; and
providing one or more options to assure that a positive cash flow position is achieved on the date, wherein the one or more options comprises a loan option.

16. The non-transitory machine-readable medium of claim 15, wherein the method further comprises displaying the merchant financial account information.

17. The non-transitory machine-readable medium of claim 15, wherein the merchant financial account information comprises financial account information of a plurality of merchants.

18. The non-transitory machine-readable medium of claim 15, wherein the one or more options comprises providing credit, building a budget, suggesting cross-border opportunities, suggesting promotions or coupons, delaying outgoing payments, or combinations thereof.

19. The non-transitory machine-readable medium of claim 15, wherein the method further comprises receiving a selection of the one or more options.

20. The non-transitory machine-readable medium of claim 19, wherein the method further comprises processing the selection of the one or more options.
